(19) United States
(12) Patent Application Publication
(10) Pub. No.: US 2010/0039445 A1
(43) Pub. Date: Feb. 18, 2010

(54) DISPLAYING INFORMATION ON MOVING OBJECTS, AND FREQUENCY CONVERTER

(75) Inventor: Jani Kangas, Espoo (FI)

Correspondence Address: BUCHANAN, INGERSOLL & ROONEY PC, POST OFFICE BOX 1404, ALEXANDRIA, VA, 22313-1404, US

(73) Assignee: ABB Oy, Helsinki (FI)

(21) Appl. No.: 12/485,602

(22) Filed: Jun. 16, 2009

(30) Foreign Application Priority Data
Aug. 14, 2008 (FI) 20085773

(51) Int. Cl. G09G 5/00; G09G 3/32

(52) U.S. Cl. 345/619; 345/83

(57) ABSTRACT

A method, equipment and frequency converter for displaying information on a moving object, the information being displayed using a light source row arranged to the moving object. The method comprises the steps of generating the information to be displayed; controlling the movement of the moving object by the frequency converter; generating control data for the light source row in accordance with information obtained from the frequency converter on the motion state of the moving object and the information to be displayed; and controlling the light sources in the light source row arranged to the moving object in accordance with the control data.

### BACKGROUND OF THE INVENTION

The invention relates to the display of information, particularly to the display of information on moving objects controlled by a frequency converter, and to a frequency converter applicable to the display of such information.

Frequency converters are commonly used for controlling rotating electric machines, such as motors. Many frequency converters employ angular speed in their internal algorithms, although the angular speed of the motor might not be regulated as such. Hence the frequency converter knows the angular speed and the direction of rotation, and often also the rotor position angle, and continuously uses this information when the motor is being controlled.

The frequency converter may receive the angular speed data from sensors mounted on the motor shaft specifically for this purpose. However, modern frequency converters are capable of estimating speed and location data of an electric machine to be controlled by measuring electric variables, i.e. voltage and current, and by using a model of the motor.

Likewise, when a motor controlled by a frequency converter is coupled to produce a linear movement, the frequency converter knows the speed and mechanical location of the movement. The linear movement in question may relate to a sliding door or a lift, for example, in which a rotating motion produced by a motor is converted into a linear movement.

Hence motors controlled by a frequency converter produce either a linear or rotating movement. Even with security issues taken into account, a mechanical piece brought to such a movement may cause hazardous situations to persons close to the pieces. In addition to actual machine safety precautions, such as safety gates and booms, moving objects are often provided with warning or informative signs. Moreover, many objects controlled by frequency converters are impossible to protect completely, so signs or similar information boards are the only alternative for taking care of the safety of persons.

In addition, information boards are often problematic to position to moving objects. The object may rotate and move linearly in such a manner that the board or the like becomes totally or partly covered due to the movement. Information boards are also often large so when position in place they unavoidably increase the size of the mechanics to be moved. Particularly if the texts or patterns of the sign board are to be produced using light emitting elements, the size of the mechanics required becomes large. For example, it is difficult to affix a sign text to a sliding door of a lift or to a revolving door so that the text is readable from the outside. Often the sliding door of a lift slides into the wall in two parts when the door opens. Hence information on the door becomes quickly hidden, and often the door mechanics do not allow light emitting elements to be fastened to the door. A revolving door in turn has a plural number of “wings” having an end width on which guiding texts are in practice impossible to attach. In addition, a sign on the outer edge of a “wing” would impair passage through the revolving door, because the sign would exceed the width of the revolving door. Moreover, information to be provided directly on a revolving piece rapidly becomes difficult to discern because of the rotation.

Prior art knows the use of “wave messaging” on hand-held devices, such as mobile phones. For this purpose the hand-held device in question is provided with an acceleration sensor and a row of light sources, such as LEDs. In wave messaging the hand-held device is waved in the air, the light sources being switched on and off on the basis of the acceleration of the device in such a way that the desired text appears “in the air” on a single light source row. In other words, the desired text is created with one light source row by producing the text horizontally of separate adjacent dots one at a time while the light source row is moving. Since the human eye is slow, a person nevertheless perceives a plurality of adjacent dots at one go and is capable of discerning comprehensible information from these adjacent dots illuminated one after the other.

Publication WO 2004/109630 discloses a LED row on a rotating piece, the row being controlled to produce a virtual text during the rotating motion. In this publication the synchronization of the generation of the text is disclosed as depending on the time of revolution of the piece.

### SUMMARY OF THE INVENTION

It is thus an object of the invention to provide a method, equipment implementing the method, and a frequency converter that allow the above problems to be solved. The object of the invention is achieved by a method, equipment and frequency converter characterized by what is stated in the independent claims. The preferred embodiments of the invention are disclosed in the dependent claims.

The invention is based on the idea of being able to place a light source row to a moving object controlled by a frequency converter so as to produce warning, guiding or other similar information by means of “air messaging”, which is controlled on the basis of information on the speed and/or location of the moving object received directly from the frequency converter.

The method, equipment and frequency converter of the invention allow information to be placed to locations where display of information has not been possible so far, or has required significant changes to existing structures. Further, with the method and equipment of the invention the display of information may be implemented in a simple and affordable manner, because no separate sensors or measurements are needed. The information content to be displayed may be further modified in a simple manner. Particularly slowly moving objects may have two parallel light source rows, for example, which enhances the display of the information and makes it more clearly visible.

### BRIEF DISCLOSURE OF THE FIGURES

In the following the invention will be described in greater detail with reference to preferred embodiments and the accompanying drawings, in which

FIG. 1 is an example of how text is generated by means of one moving light source row;

FIG. 2 is an example of a virtual matrix formed by a light source row on a rotating object;

FIG. 3 illustrates an embodiment of the invention in connection with a revolving door;

FIG. 4 illustrates an embodiment of the invention in connection with sliding doors;

FIGS. 5 and 6 illustrate an embodiment of the invention in connection with a rotating piece; and

FIG. 7 illustrates an embodiment of the invention in connection with a rotating piece.

### DETAILED DISCLOSURE OF THE INVENTION

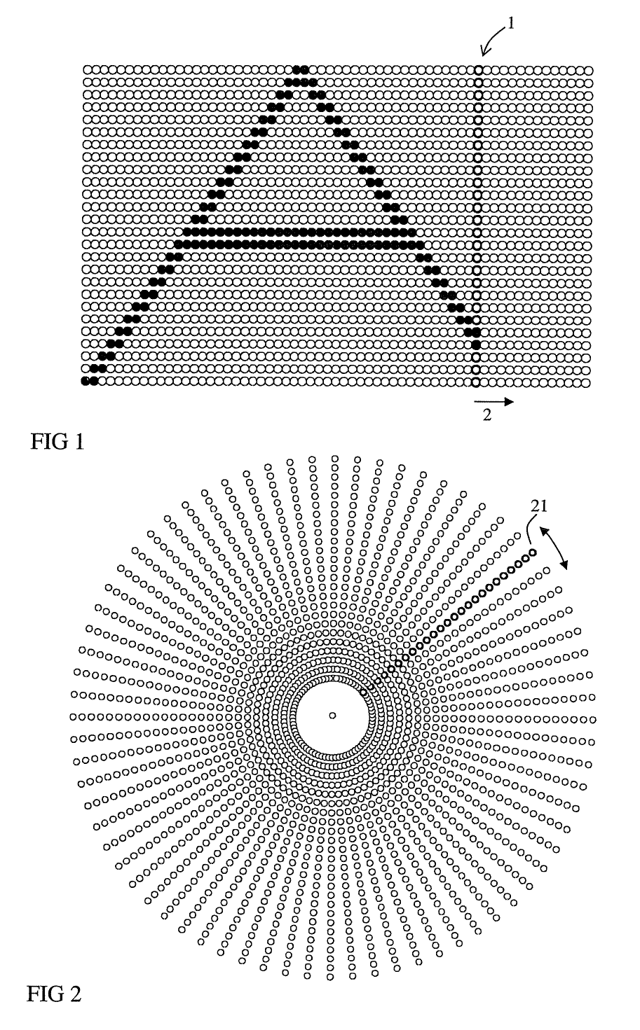

FIG. 1 is a schematic view of a light source row of the method and equipment of the invention with the row in movement, and a virtual matrix created with this light source row. The light source row 1, which is arranged to a moving object as disclosed in the invention, moves in the direction of arrow 2 along with the piece. The light sources, such as LED components, in the light source row are shown as darkened unfilled circles in the virtual matrix. The virtual matrix dots already illuminated by the light source row 1 are in turn shown as filled circles. In the solution of the invention light sources of the light source row 1 attached to the moving object are switched on and off depending on the text to be displayed and the location of the light source row.

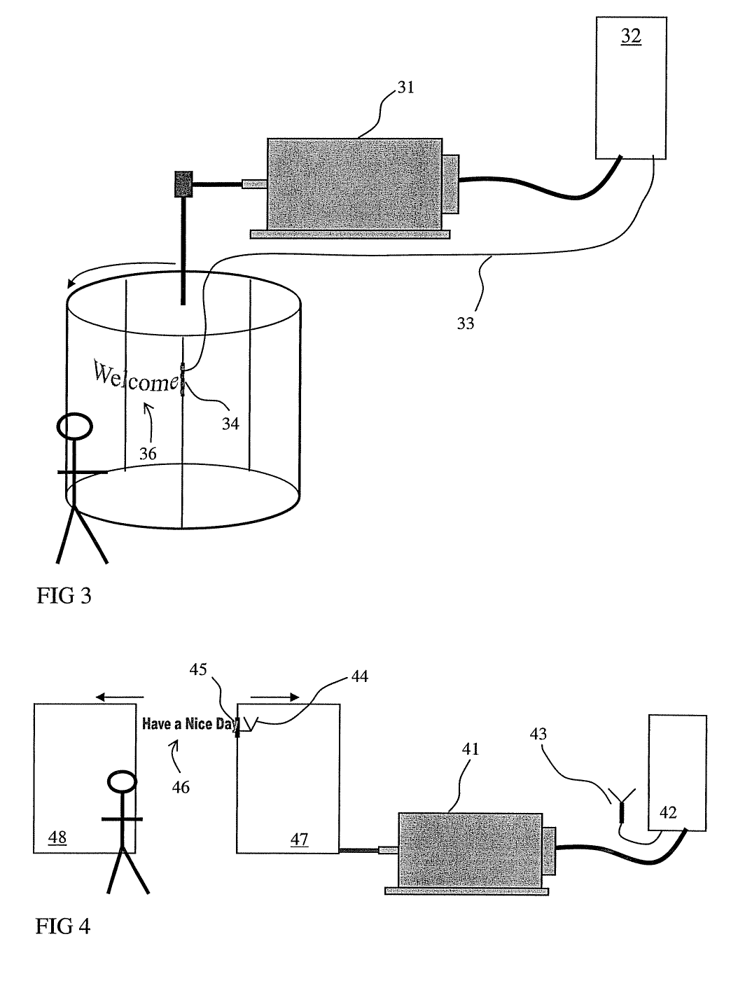

FIG. 3 shows an embodiment of the invention in which a motor 31 controlled by a frequency converter 32 is used for rotating a revolving door. A light source row 34 is fastened to the jamb of a “wing” of the revolving door, i.e. to the end of a wall extending radially from the centre of the revolving door. Hence the light source row moves as the revolving door revolves.

According to the embodiment of the invention the frequency converter contains the information to be displayed, the information having been entered into the memory of the frequency converter by means of an input device for inputting text. Any text input method known per se may be used for supplying the text and for transferring it into the memory of the frequency converter. It is conceivable that the text may be supplied using the control panel of the frequency converter, an external keyboard, a portable computer or the like.

Further, according to the embodiment of the invention the frequency converter is used for controlling the light source row. Frequency converters controlling a motor contain motor control data for carrying out the control. Frequency converters typically have a lot of processing capacity that may be utilized in accordance with the invention for computing control data of the light sources on the basis of the motor control data and the information to be displayed. FIG. 3 shows a signal conductor 33 through which the frequency converter controls the light source row on the basis of the control data it has computed. The information transmitted on the signal conductor may comprise information about the addresses of the light sources that are to be switched on or kept live, for example.

In connection with the example of FIG. 3 the control data may be computed in a simple manner when the motor speed and the information to be displayed are known. If the speed of the light source row is v [m/s] and new illuminating dots are switched on when the light source row has travelled for a distance s [m], these new illumination dots are to be switched on after a time period s/v [t]. The time thus selected determines the distance s as the horizontal resolution of the information produced with the light source row. The determined control data may be computed in advance and tabulated into the frequency converter memory, whereby light sources to be illuminated at the next time instant may be read directly from the memory. It is also possible to compute the control data in real time in a similar manner.

As regards FIG. 3, it is also conceivable that the frequency converter 32 produces through the signal conductor 33 only status data on the circumferential speed and/or position angle of the revolving door. In that case a processor and readable memory containing the data on the information to be displayed are provided in connection the light source row. The processor then processes the control data it receives and controls the light source row to produce information as described above. In this procedure the frequency converter does not need to contain any extra functions but only means for transmitting the data over the signal conductor.

FIG. 4 illustrates the method and equipment of the invention applied in connection with sliding doors 47, 48 of a lift. In this embodiment the sliding door of the lift carries a light source row 45, such as a LED row, for displaying information as the door opens and/or closes. In FIG. 4 the LED row is on the door 47, but on a double door a LED row may be placed also to the door 48, the LED rows being thus capable of displaying the information together so that the information 46 is displayed on the doors sliding to their respective directions. The structure of FIG. 4 shows an embodiment of the invention in which the control data produced by the frequency converter 42 to control the light source row is transferred to the light source row wirelessly. For this purpose FIG. 4 shows a transmitter 43 and a receiver 44. The information to be transmitted wirelessly may also consist of data on the motion state of the sliding doors, in which case a processor provided in connection with the LED row generates the control data for the individual LED light sources in the row on the basis of the information to be displayed and the data on the motion state contained in the memory arranged in connection with the processor. An advantage of a wireless transmission is that cables may be disposed of, as signaling over a wired signal connection may often be complicated to implement on a moving object. In addition, the receiver provided in connection with the light source row may be used also for updating the information to be displayed.

It is to be noted that on linearly moving objects, such as sliding doors, information is visible to one direction only. In the above embodiment, for example, the information in connection with the lift door is only visible to the outside of the lift. However, LED rows on a moving object may be arranged to face away from each other, which allows information to be displayed to both directions, i.e. to those entering the lift and those exiting it. Further, separate LED rows on the same moving object may display different information. In connection with the lift mentioned here, for example, the information displayed to those exiting the lift is the floor number, whereas those entering the lift are shown the travel direction of the lift, for example, together with other information, such as a welcome message.

FIG. 5 shows an embodiment of the invention, in which the light source row 55 is arranged to a rotating device 56 rotated by a motor 51 controlled by a frequency converter 52. Data transfer to the LED row 55 attached to the rotating device takes places wirelessly by means of a transmitter 53 suitable for the purpose and a receiver connected to the rotating device.

As explained above, the frequency converter 52 may contain the information to be displayed, in which case the frequency converter transmits the control data directly to the light sources or, alternatively, the frequency converter transmits only data on the motion state, such as position angle data, to a processor provided in connection with the light sources. FIG. 5 further shows examples of the information 57, 58 to be displayed. When the rotating object is for example a fan or the like 56 on whose blade the LED row is provided, the level of rotation of the fan blades may be utilized for displaying the information. With a fan like this in public premises it is conceivable that the information to be displayed could also be commercial information.

When a frequency converter is used for controlling a motor having only a disc, or the like, on its shaft for educational, training and demonstration purposes, information relating directly to the characteristics of the motor and/or frequency may be displayed on the disc in accordance with the invention. Reference numeral 58 illustrates how the frequency of the speed of rotation of the disc is shown on the disc. In that case the frequency converter must produce dynamic information to be displayed according to the invention. Other information to be displayed in this manner may include magnitudes of frequency converter currents and voltages and generally all motor-control-related variables applied by the frequency converter. For educational, training and demonstration purposes the information may also consist of displaying phasor variables. The method and equipment of the invention thus allow real-time information to be displayed. When such real-time information is to be displayed, the information is not stored into a memory in advance but processed in real-time for display by the light source row.

FIG. 2 illustrates a rotating light source row 21 and a virtual light source pattern formed by it. In other words, the light source row is arranged to a rotating piece in such a way that the axis of rotation of the rotating piece is substantially perpendicular to the light source row. In FIG. 2 the rotating LED row is presented as if it formed discrete dots, the angle between the positions of adjacent LED rows in the figure being 5 degrees. However, it is obvious that during rotation the angle of the LED row changes in a continuum and not at discrete points as in the figure. In the cases of FIGS. 2 and 5 the individual light sources are preferably controlled on the basis of the position angle of the rotating piece. In other words, when the light source row is in a particular position, specific light sources are switched on, off or left at an illuminating state for producing a desired text or graphic. This angle data is available from the frequency converter for this purpose. An unlimited number of light source rows used in the invention may be chained together, which allows the same information to be displayed to different directions in connection with a rotating piece, for example. An advantage of the chaining is that it allows information to be displayed to two directions and at a plural number of different locations without separate outputs from the frequency converter to each light source row. Chaining also allows matrix size to be increased, and the chained rows may have independent addresses, thus allowing different information to be sent to the chained rows for display.

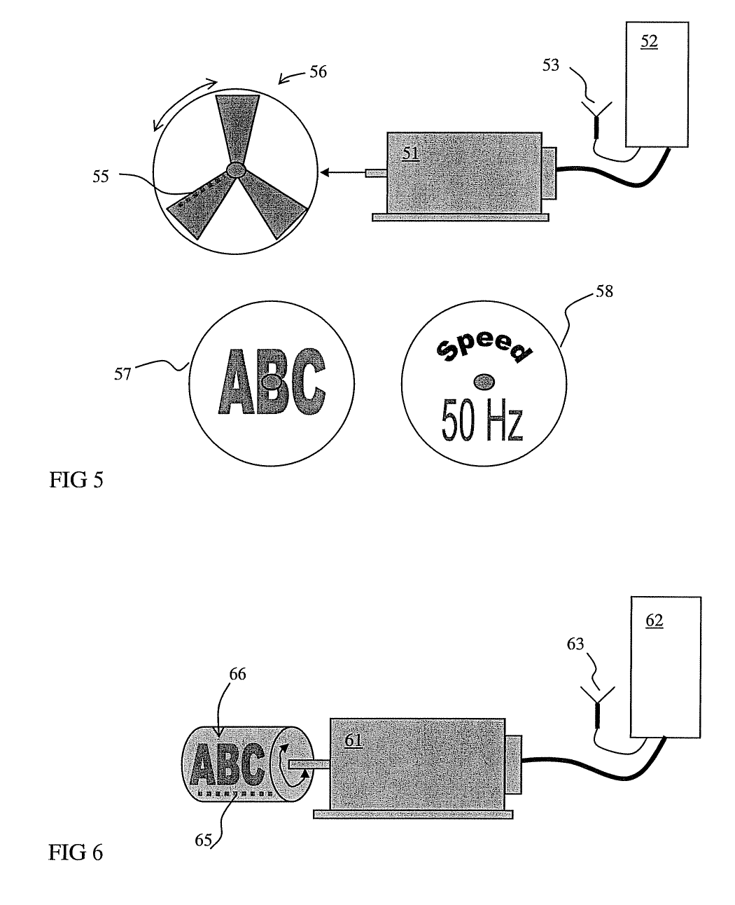

FIG. 6 shows an embodiment of the invention in which a frequency converter 62 controls a motor 61, the motor having a drum or the like mounted to its shaft. In this example the frequency converter is connected to a transmitter 63 for transmitting the control data of the light sources or information on the motion state of the moving object to a receiver arranged in connection with a light source row 65. In the example of FIG. 6 the light source row is arranged to the circumferential surface of the drum or the like in such a way that the axis of rotation of the drum is mainly parallel with the light source row, the direction of movement of the light source row thus being perpendicular to the longitudinal direction of the drum. In this type of example a text warning of a rotating piece, for example, or some other information 66 may be written on the side of the drum.

The equipment of the invention, in which the information to be displayed is supplied to the frequency converter and the frequency converter produces the control data to the light source row, serves as a display controller for a rotating or moving display. The rotating motion of the motor is only used to rotate or move the light source row; no actual process that would benefit from the motion thus produced is involved. The display in question may be large and the light source row may consist of a plural number of light sources of different colours. In this type of display the light source row preferably comprises light sources of different colours arranged into groups with a red, green and blue light source in one group, for example. The light sources are preferably LED components that allow a good dot-like lighting to be achieved. Alternatively, in the case of a rotating display such as the one in FIG. 2, light source rows of different colours may be placed at mutually different angles symmetrically, for example, with an angle of 120 degrees between the light source rows consisting of different colours. During a rotating motion each light source row is then controlled by different controls to synchronise the rows. In practice, with the three colours mentioned above it is possible to produce a plural number of colours and thus create multicolour information. This means that also information about the colours and possibly their intensity must be contained in the information to be displayed which is supplied to the frequency converter. When the display device is configured with the method of the invention as described above, it is conceivable that the information to be displayed which is supplied to the frequency converter may change arbitrarily during use. This information may be supplied to the frequency converter by using a field-bus or the like, for example. For this purpose the frequency converter may contain a separate application aimed at facilitating the supply of the information to be displayed and at enhancing the operation of the display controller.

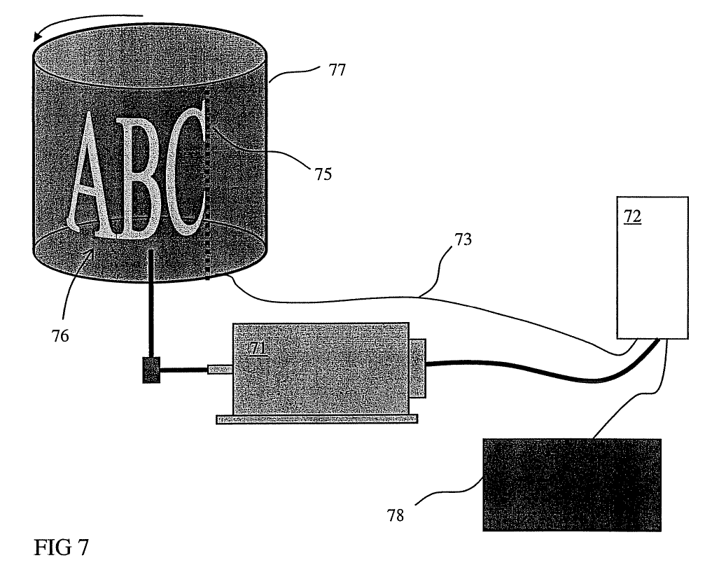

According to the embodiment of FIG. 7 the equipment further comprises a computer or the like 78 to which the frequency converter 72 provides control data on the basis of which the user may construct a display device of his/her choice. FIG. 7 shows how the frequency converter 72 supplies a motor 71 that rotates a drum 77 serving as the display. The drum 77 is provided with a light source row 75 connected thereto for displaying 76 information during the rotating motion of the drum. The timing of the control of the light sources is taken care of by the computer on the basis of information on rotation state provided by the frequency converter. The drum 77 may also be provided with light sources of different colours for displaying multicolour information. Light sources of different colours, such as LED components, may be placed at different positions on the rotation surface of the drum, for example at a mutual phase shift of 120 degrees. The drum in question enables to construct a display device allowing information to be displayed to a plural number of directions at the same time. For example, the same information may be displayed on both the front and the rear side of the drum, i.e. at a phase shift of 180 degrees.

According to an embodiment of the invention, means for checking the operating condition of one or more light sources are provided in connection with the light source row. These means may consist of a processor and a comparator coupling, for example, for measuring voltage across one or more light sources. On the basis of this voltage it is possible to draw conclusions on the operating condition of the light source. Further, according to this embodiment there are means arranged to send the information on the operating condition to the frequency converter. In other words, after the operating condition of the light source, such as a LED component, has been measured, the measurement data is transmitted to the frequency converter.

The data to be transmitted may consist of failure information alone, i.e. when the light sources operate normally, no data is transmitted. On the basis of this measurement data the operation of the frequency converter is either allowed or prevented, i.e. if the frequency converter is operating and supplying a load at the time a failure is detected, its use is interrupted and, correspondingly, the use cannot be started when a failure notice has been given. This embodiment is particularly advantageous when the light source row produces a warning text, because an inoperative warning sign is a major safety risk. Hence the operation of a frequency converter is not to be allowed when the warning is not functioning. The invention has been disclosed above with reference to LED light sources in particular. Control circuits of light sources or LED light sources, i.e. the circuits providing the light sources with the current or voltage they need, have not been given much attention. However, it is obvious that such circuits are needed in light source components, and they may be implemented in any manner known per se in the industry.

Although in connection with some of the above structures attention has been drawn to the fact that the frequency converter generates and transmits only information illustrating the motion state of a moving object, the information to be transmitted may also consist of the control data of the light source row. In that case the frequency converter of the invention comprises a processor, memory and the necessary computational capacity for computing the control data on the basis of the information to be displayed and the data representing the motion state.

There various alternatives for controlling a light source row in accordance with the invention. The light source rows may be provided with an analogous message to communicate the speed on the basis of which the processor provided in connection with the light source row controls the light sources in the light source row. Also angle data or location data may be communicated from the frequency converter to said processor. It is to be noted that the human eye is not very sensitive for disturbing phenomena, i.e. minor errors in speed do not disturb the detection of information in a linear movement. However, such errors may be corrected by using a separate digital output of the frequency converter, for example, in connection with analogous speed, position or angle data to trigger the writing at a precise moment.

The information produced by the frequency converter and on the motion state may also consist of a frequency output, i.e. information on the frequency to be supplied to the motor to be controlled. This may be further assisted by a digital output transferring serial data by means of the frequency output.

If the light source row is almost a passive unit, data may be transferred in a serial mode by supplying first the desired pattern (one vertical row in the case of FIG. 1) to the registers of the light sources in said unit. The pattern of this vertical row is trigger for display at a right moment on the basis of speed and location data.

An excellent way of controlling the light source row is to adjust the light source row to emulate an ordinary frequency converter display panel, which is typically an LCD matrix. In that case the light source row may be connected to the frequency converter through an ordinary, either wired or wireless, display panel connection. Hence the light source row thus connected is simple to control because information to the light source row may be transmitted by using a data transfer protocol used normally as well. Ordinary display panels such as these support chaining, which means that the light source row may operate chained with the display panel. Light source rows coupled to a panel connection may be chained correspondingly.

Another method of controlling the light source row is to provide the light source row with a writing speed informed through the frequency converter. In that case the processor provided in connection with the light source row is used for computing a matrix, as shown in FIG. 1, the writing being then carried out according to the writing speed, i.e. the delay between the vertical rows, informed by the frequency converter.

Yet another way of controlling the light source row in accordance with the invention is based on changes in movement. In that case the frequency converter informs the processor of the light source row about the state of its system only at the beginning of a speed change or start-up. When the operating speed is constant, the frequency converter simply triggers the display of the desired information by a single signal.

The information to be displayed may also be transferred in a matrix, in which case the matrix form is selected in the frequency converter in accordance with the application concerned. The user may scale the desired information on the frequency converter display to suit the selected form and the matrix resolution. The writing of the matrix is then taken care of by the light source row, which identifies the control data obtained from the frequency converter on the basis of the matrix form (such as rectangular; FIG. 1, and round; FIG. 2) and uses the information accordingly.

It is obvious to a person skilled in the art that as technology advances the basic idea of the invention may be implemented in various ways. The invention and its embodiments are therefore not restricted to the above examples but may vary within the scope of the claims.

1. A method for displaying information on a moving object, the information being displayed using a light source row arranged to the moving object, wherein the method comprises the steps of
generating the information to be displayed;
controlling the movement of the moving object by a frequency converter;
generating control data for the light source row in accordance with information obtained from the frequency converter on the motion state of the moving object and the generated information to be displayed; and
controlling the light sources in the light source row arranged to the moving object in accordance with the control data.

2. A method according to claim 1, wherein the information to be displayed is stored into the frequency converter and that the control data for the light source row is generated in the frequency converter.

3. A method according to claim 1, wherein the frequency converter controls the light sources in the light source row in accordance with the control data.

4. A method according to claim 1, wherein the information to be displayed is stored into the memory of a processing device provided in connection with the light source row;
the frequency converter transmits information on the motion state of the moving object to the processing device; and
the processing device generates the control data for the light source row and controls the light sources in the light source row.

5. A method according to claim 1, wherein the method further comprises the steps of
checking the operating condition of one or more light sources in the light source row; and
transmitting information on the operating condition to the frequency converter; and
allowing or preventing the operation of the frequency converter in response to the operating condition.

6. Equipment for displaying information on a moving object, the information being arranged to be displayed using a light source row arranged to the moving object, wherein the equipment comprises
means for generating information to be displayed;
a frequency converter arranged to control the movement of the moving object;
means for generating control data for a light source row in accordance with information obtained from the frequency converter on a motion state of the moving object and the generated information to be displayed; and
means for controlling the light source row arranged to the moving object in accordance with the control data of the light source row.

7. Equipment according to claim 6, wherein the frequency converter comprises a memory for storing the information to be displayed and a processor for generating the control data for the light source row.

8. Equipment according to claim 6 wherein the frequency converter is arranged to control the light sources in the light source row in accordance with the control data.

9. Equipment according to claim 7, wherein the equipment further comprises a processing device arranged in connection with the light source row and a readable memory into which the information to be displayed is arranged to be stored, the frequency converter being arranged to transmit the information on the motion state of the moving object to the processing device and the processing device being arranged to generate the control data for the light source row and to control the light sources in the light source row.

10. Equipment according to claim 7, wherein the frequency converter is arranged to transmit the control data to the light source row and/or the information on the motion state of the moving object over a wireless connection.

11. Equipment according to claim 7, wherein the information on the motion state of the moving object comprises the speed, angular speed, location, angle of position and/or direction of movement of the moving object.

12. Equipment according to claim 7, wherein the moving object comprises a plural number of light source rows in which the light sources include LED components comprising one or more colours.

13. Equipment according claim 7, wherein in connection with the light source row there are provided means for checking an operating condition of one or more light sources and means for transmitting the information on the operating condition to the frequency converter, the operation of the frequency converter being allowed or prevented in response to the information on the operating condition.

14. Equipment according to claim 7, wherein two or more light source rows are chained together, thus allowing a matrix to be formed of the light source rows to enhance the display of information to be displayed in connection with a slow movement or the chained light source rows allowing mutually different information to be displayed because of different light source row addresses.

15. A frequency converter which comprises a readable memory and a processing member and which is configured to control the movement of a moving object, wherein the readable memory of the frequency converter is arranged to receive information that is arranged to be displayed using a light source row arranged in connection with the moving object controlled by the frequency converter, the processing member of the frequency converter being arranged to generate and transmit the control data of the light source row in accordance with the information on the a motion sate of the moving object and the stored information to be displayed.
